(19) United States
(12) Patent Application Publication
(10) Pub. No.: US 2026/0249621 A1
(43) Pub. Date: Aug. 27, 2026

(54) RECORDING APPARATUS

(71) Applicant: SEIKO EPSON CORPORATION, Tokyo (JP)

(72) Inventors: Motofumi OTANI, MATSUMOTO-SHI (JP); Hibiki HARATA, SHIOJIRI-SHI (JP); Naohiro UEYAMA, MATSUMOTO-SHI (JP)

(21) Appl. No.: 19/422,751

(22) Filed: Dec. 17, 2025

(30) Foreign Application Priority Data
Dec. 20, 2024 (JP) 2024-224994

(51) Int. Cl. B41J 11/00; B41J 15/04; B41J 15/16

(52) U.S. Cl. CPC B41J 11/00212; B41J 11/00218; B41J 15/048; B41J 15/165

(57) ABSTRACT

A recording apparatus includes a conveyance roller pair including a main roller configured to convey a medium in a conveyance direction, and a plurality of sub-rollers disposed at intervals along a width direction crossing the conveyance direction and configured to pinch the medium with the main roller, a recording head configured to perform recording on the medium, a guide roller disposed downstream in the conveyance direction of the conveyance roller pair and configured to apply tension to the medium, and a light source unit configured to irradiate, with visible light, a surface region of the medium conveyed in the air between the conveyance roller pair and the guide roller, wherein luminous intensity in the width direction of the visible light with which the light source unit irradiates the surface region is higher than luminous intensity thereof in the conveyance direction.

### CROSS-REFERENCE TO RELATED APPLICATIONS

The present application is based on, and claims priority from JP Application Serial Number 2024-224994, filed Dec. 20, 2024, the disclosure of which is hereby incorporated by reference herein in its entirety.

### BACKGROUND

### 1. Technical Field

The present disclosure relates to a recording apparatus.

### 2. Related Art

JP-A-2014-24643 discloses an inkjet recording apparatus including a recording head that ejects a liquid onto a medium, a medium conveyance mechanism that pinches and conveys the medium, and a tension roller that applies tension to the medium. In this inkjet recording apparatus, recording is performed by ejecting the liquid from the recording head onto the medium conveyed in the air between the medium conveyance mechanism and the tension roller.

JP-A-2014-24643 is an example of the related art.

In the inkjet recording apparatus described in JP-A-2014-24643, there is adopted a configuration in which the medium is conveyed in the air by pulling the medium between the medium conveyance mechanism and the tension roller, and therefore, wrinkles may occur in the medium in some cases when the medium is as soft as fabric. When recording is performed on the medium in a state in which the medium is wrinkled, there is a possibility that deterioration of the image quality of the image recorded on the medium or a failure of the recording head occurs.

### SUMMARY

A recording apparatus includes a conveyance roller pair including a main roller configured to convey a medium in a conveyance direction, and a plurality of sub-rollers disposed at intervals along a width direction crossing the conveyance direction and configured to pinch the medium with the main roller, a recording head configured to perform recording on the medium, a guide roller disposed downstream in the conveyance direction of the conveyance roller pair and configured to apply tension to the medium, and a light source unit configured to irradiate, with visible light, a surface region of the medium conveyed in air between the conveyance roller pair and the guide roller, wherein luminous intensity in the width direction of the visible light with which the light source unit irradiates the surface region is higher than luminous intensity thereof in the conveyance direction.

### BRIEF DESCRIPTION OF THE DRAWINGS

FIG. 1 is a perspective view schematically showing a recording apparatus.

FIG. 2 is a schematic diagram showing an internal structure of the recording apparatus.

FIG. 3 is a plan view schematically showing an irradiation state of a light source unit.

FIG. 4 is a diagram showing a concept of the irradiation state of the light source unit.

FIG. 5 is a plan view schematically showing an irradiation state of a light source unit in a second embodiment.

FIG. 6 is a diagram showing a concept of the irradiation state of the light source unit in the second embodiment.

FIG. 7 is a plan view schematically showing an irradiation state of a light source unit in a third embodiment.

FIG. 8 is a diagram showing a concept of the irradiation state of the light source unit in the third embodiment.

FIG. 9 is a plan view schematically showing an irradiation state of a light source unit in another embodiment.

### DESCRIPTION OF EMBODIMENTS

### 1. First Embodiment

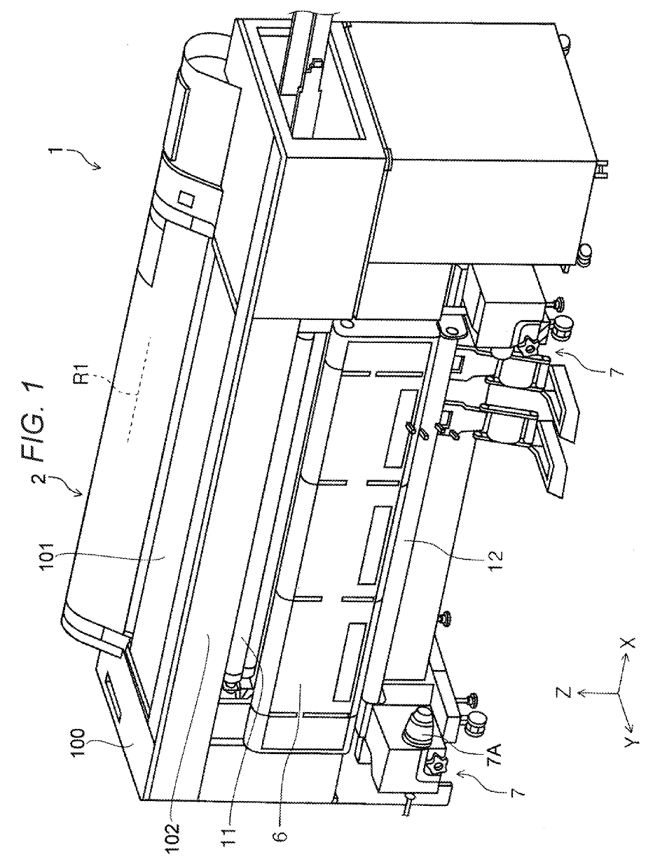

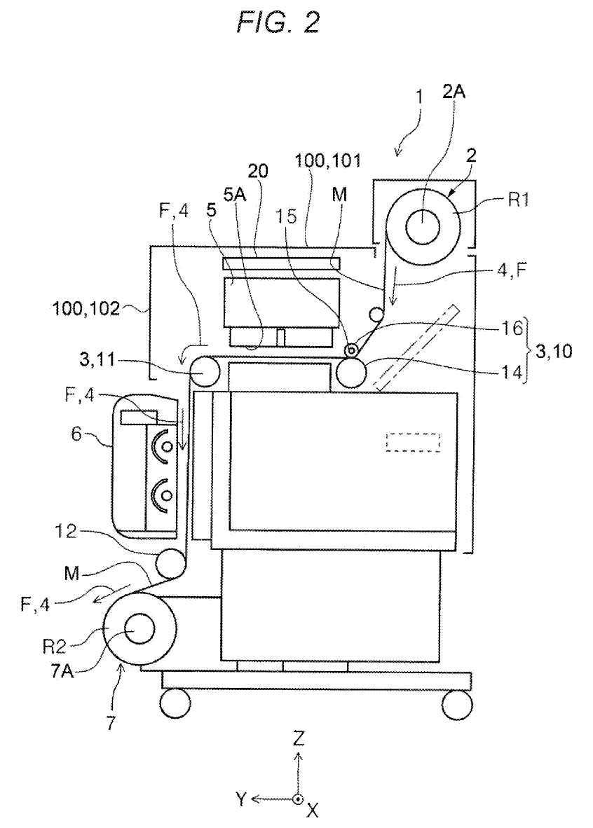

A recording apparatus 1 according to the present embodiment will hereinafter be described with reference to the drawings. The recording apparatus 1 illustrated in FIG. 1 is, for example, an inkjet printer that records an image such as a character or a photograph on a medium M by ejecting ink, which is an example of a "liquid," onto the medium M (see FIG. 2) that is conveyed.

In the drawings described below, the scale of each member is made different from the actual scale in order to show each member in a recognizable size. Further, in the drawings, the same components are denoted by the same reference numerals, and redundant descriptions thereof are omitted. Further, in the drawings, an X axis, a Y axis, and a Z axis are illustrated as needed as coordinate axes orthogonal to each other. The X axis, the Y axis, and the Z axis are respectively attached with arrows. In each of the X axis, the Y axis, and the Z axis, the arrow direction is a positive direction, and a direction opposite to the arrow direction is a negative direction.

Hereinafter, for the sake of convenience of explanation, the positive direction of the X axis is also referred to as a rightward direction or simply right, and the negative direction is also referred to as a leftward direction or simply left in the following description. In addition, in the following description, the positive direction of the Y axis is also referred to as a frontward direction or simply front, and the negative direction is also referred to as a rearward direction or simply rear. In addition, in the following description, the positive direction of the Z axis is also referred to as an upward direction or simply upside, and the negative direction is also referred to as a downward direction or simply downside.

Note that a direction parallel to the X axis is a width direction of the recording apparatus 1 and corresponds to a width direction of the medium M on which an image is recorded. A direction parallel to the Y axis corresponds to a depth direction of the recording apparatus 1. Further, viewing from the +Z direction or the -Z direction is referred to as a plan view.

As illustrated in FIGS. 1 and 2, the recording apparatus 1 includes a feeder 2 that feeds the medium M, a conveyance unit 3 that conveys the medium M, a recording head 5A that records an image on the medium M, a heating unit 6 that dries the medium M on which the recording has been performed, and a winder 7 that winds the medium M on which the recording has been performed.

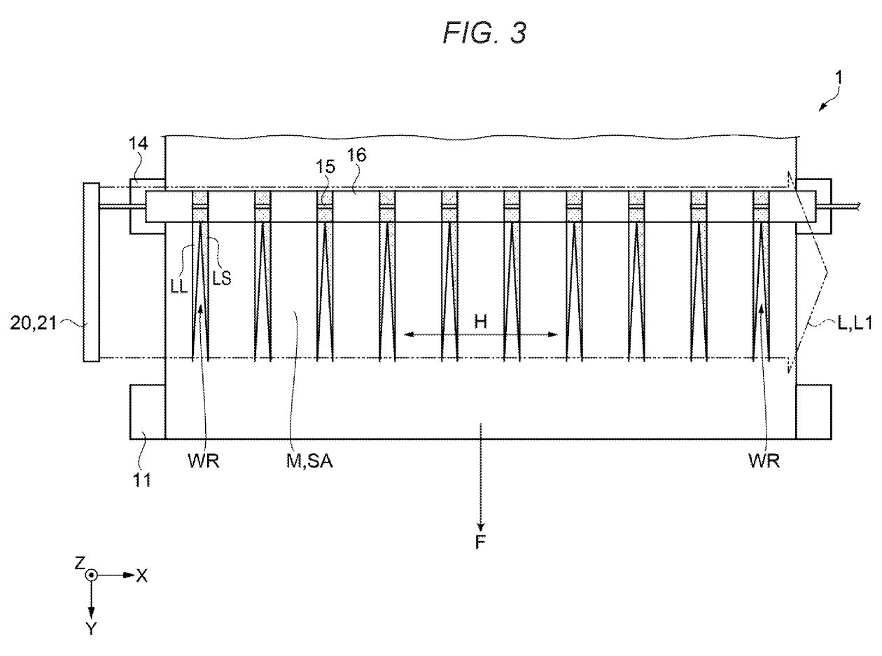

The medium M is conveyed in a conveyance direction F on the conveyance path 4 by the conveyance unit 3. The recording apparatus 1 of the present embodiment conveys the medium M while applying appropriate tension to the medium M with a conveyance method called a Roll-to-Reel conveyance method. The recording head 5A disposed in the middle of the conveyance path 4 records an image on a surface region SA (see FIG. 3) of the medium M described later by ejecting a liquid onto the medium M. The medium M on which the image has been recorded is dried by heat of the heating unit 6 disposed along the conveyance path 4, and is wound by the winder 7. In the present embodiment, the recording head 5A is mounted on a moving unit 5. The moving unit 5 is movable in a width direction H (see FIG. 3) crossing the conveyance direction F. The recording head 5A in the present embodiment records an image on the medium M by a serial head system.

The recording apparatus 1 can perform textile printing on the medium M such as a long fabric. Examples of the fabric include a woven fabric, a knitted fabric, and a nonwoven fabric of natural fiber such as cotton, silk, or wool, chemical fiber such as nylon, and composite fiber as a mixture thereof.

As shown in FIG. 2, a roll body R1 is rotatably supported by the feeding shaft 2A of the feeder 2. The medium M on which an image is to be recorded is rolled into the roll body R1. The conveyance unit 3 includes a conveyance roller pair 10 that applies feeding force in the conveyance direction F to the medium M, and a guide roller 11 located downstream in the conveyance direction F of the conveyance roller pair 10.

The conveyance roller pair 10 includes a main roller 14 that conveys, in the conveyance direction F, the medium M fed from the roll body R1, and a plurality of sub-rollers 16 (see FIGS. 2 and 3) that pinches the medium M with the main roller 14. The sub-rollers 16 are rotatably supported with a first shaft 15 as a rotary shaft. The conveyance direction F of the medium M fed from the roll body R1 is changed from the substantially downward direction to the +Y direction by winding the medium M around the sub-rollers 16.

In the present embodiment, the main roller 14 is a driving roller, and the sub-rollers 16 are driven rollers. The driving roller is rotationally driven by power from a motor or the like. The driven rollers are driven by the driving roller rotationally driven. Note that there may be adopted a configuration in which the sub-rollers 16 are the driving rollers, and the main roller 14 is a driven roller. Further, the main roller 14 and the sub-rollers 16 may be reversed in arrangement. In this case, the conveyance direction F of the medium M is changed from the substantially downward direction to the +Y direction by being wound around the main roller 14.

The guide roller 11 is disposed downstream in the conveyance direction F of the conveyance roller pair 10 and applies tension to the medium M. The guide roller 11 is, for example, a drive roller that rotates by power from a motor (not illustrated) or the like. The guide roller 11 may be a driven roller that rotates due to a frictional resistance received from the medium M and applies tension to the medium M together with a guide bar 12.

The medium M is conveyed in the air between the conveyance roller pair 10 and the guide roller 11. In the present embodiment, in the region of the medium M, a region of the surface of the medium M facing to the +Z direction and located between a region in contact with the conveyance roller pair 10 and a region in contact with the guide roller 11 is referred to as the surface region SA. The surface region SA can face the recording head 5A and is a region along an X-Y plane including the X axis and the Y axis. The recording head 5A records an image by ejecting the liquid onto the surface region SA of the medium M at a position downstream in the conveyance direction F of the conveyance roller pair 10 and upstream in the conveyance direction F of the guide roller 11.

The medium M on which the image has been recorded is conveyed toward the heating unit 6 disposed between the guide roller 11 and the guide bar 12. The heating unit 6 includes a heater, and dries the liquid ejected onto the medium M by the heater generating heat. The guide bar 12 is disposed between the guide roller 11 and the winder 7. The guide bar 12 comes into contact with the medium M and applies tension to the medium M. The medium M passing through the guide bar 12 is rolled into a roll body R2 pivotally supported by a take-up shaft 7A of the winder 7. The take-up shaft 7A rotates the roll body R2 with power from a motor (not illustrated) or the like.

The recording apparatus 1 includes a light source unit 20 capable of irradiating the surface region SA of the medium M with visible light L (see FIG. 3). Examples of the light source unit 20 include, but are not limited to, a white LED. For example, the light source unit 20 may be a light source formed of a light bulb, an electroluminescence light source, a semiconductor laser, or the like. Further, the color of the visible light L emitted from the light source unit 20 may be a color other than white, but in that case, the higher the luminance of the visible light L, the more preferable. Further, it is more preferable for the visible light L emitted from the light source unit 20 to have a predetermined directional characteristic centered on the optical axis.

As illustrated in FIGS. 1 and 2, the recording apparatus 1 includes a housing 100 that defines a part of an outer shell of the recording apparatus 1. The housing 100 houses at least the conveyance roller pair 10, the guide roller 11, and the light source unit 20. In the housing 100, a window portion 101 is disposed at a top surface which is a surface at the +Z direction side of the housing 100. In the housing 100, a window portion 102 is disposed at the front surface which is a surface at the +Y direction side of the housing 100. The window portions 101, 102 allow the medium M conveyed in the air between the conveyance roller pair 10 and the guide roller 11 to be visually recognized. The window portions 101, 102 have a light transmissive property and are disposed so that the surface region SA of the medium M irradiated with the visible light L can be visually recognized.

In order to reduce the influence of the transmitted light incident from the outside of the housing 100 through the window portions 101, 102 on a shadow LS (see FIG. 3), the window portions 101, 102 are each formed of a member the light transmittance of which is not too high, that is, a member that attenuates the transmitted light. The window portions 101, 102 may be subjected to processing such as non-glare processing of diffusely reflecting light to be incident on the window portions 101, 102 from the outside of the housing 100 with fine irregularities.

As illustrated in FIG. 3, the plurality of sub-rollers 16 rotatably supported with the first shaft 15 as the rotary shaft is arranged at intervals along the width direction H crossing the conveyance direction F. The medium M is pinched between the main roller 14 and the sub-rollers 16. Meanwhile, a region of the medium M located between the sub-rollers 16 adjacent to each other is not pinched between the main roller 14 and the sub-roller 16, and is therefore uplifted in some cases more than a region pinched therebetween. The uplifted region of the medium M may form a wrinkle WR having a convex shape in some cases. In particular, when the medium M to be conveyed has a soft structure such as fabric, expansion and contraction or deformation of the medium M is likely to occur depending on the presence or absence of pinching by the main roller 14 and the sub-roller 16, and wrinkle WR may occur in some cases in the medium M.

As described above, each of the regions between the plurality of sub-rollers 16 arranged at intervals along the width direction H may become a starting point of occurrence of the wrinkle WR in some cases. Further, as the medium M is conveyed toward the guide roller 11, the wrinkle WR generated in the medium M may extend downstream in the conveyance direction F of the sub-roller 16 in some cases. In this way, the wrinkle WR may occur in some cases in the surface region SA of the medium M.

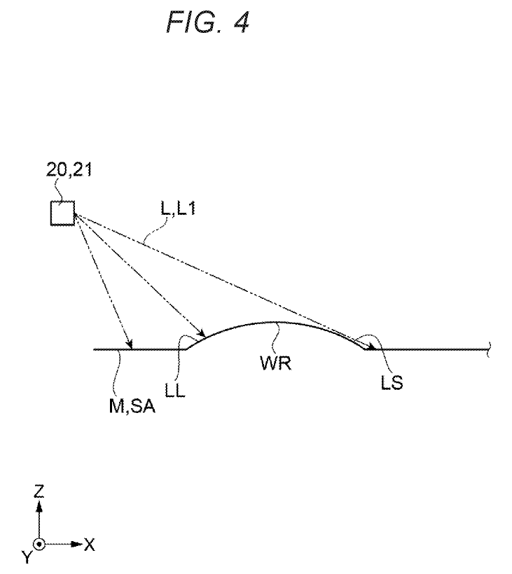

The recording apparatus 1 has a configuration for allowing visual recognition of the wrinkle WR generated in the surface region SA of the medium M. Hereinafter, a configuration for allowing the visual recognition of the wrinkle WR generated in the surface region SA of the medium M will be described with reference to FIGS. 3 and 4. Note that FIG. 3 illustrates a state in which the moving unit 5 and the recording head 5A stand by at a home position located at the +X direction side of the recording apparatus 1, and thus the moving unit 5 and the recording head 5A are not illustrated.

As illustrated in FIG. 3, the recording apparatus 1 includes the light source unit 20 outside a -X direction end portion of the medium M. The light source unit 20 includes a first light source 21. In the present embodiment, as the first light source 21, a light source formed of at least one white LED having a predetermined directional characteristic is exemplified. The first light source 21 is disposed outside the -X direction end portion of the surface region SA of the medium M in the width direction H.

The first light source 21 can emit the visible light L toward the sub-rollers 16 and regions located downstream in the conveyance direction F of the sub-rollers 16 out of the surface region SA of the medium M.

Note that the visible light L emitted from the first light source 21 includes large amount of light emitted in a direction along an optical axis and also includes light diffused in other directions. In the present embodiment, the optical axis of the first light source 21 is directed to the surface region SA of the medium M located at the +X direction side of the first light source 21 out of the width direction H. That is, it is configured that the luminous intensity in the width direction H of the visible light L emitted from the first light source 21 to the surface region SA is higher than the luminous intensity thereof in the conveyance direction F. Out of the visible light L emitted from the first light source 21, light emitted in a direction along the optical axis is hereinafter referred to as first irradiation light L1. The first irradiation light L1 is emitted toward the surface region SA of the medium M located at the +X direction side of the first light source 21 out of the width direction H.

Accordingly, when the wrinkle WR extending in the conveyance direction F is present in the surface region SA of the medium M, the shadows LS of the wrinkles WR are formed in the surface region SA of the medium M by the first irradiation light L1 emitted from the first light source 21. In FIG. 3, the shadows LS are hatched. The shadow LS is a dark portion darker than the surroundings other than the shadow LS. In the present embodiment, the shadow LS is formed at the +X direction side of a ridge line of the wrinkle WR. In addition, the bright portion LL brighter than the surroundings is formed at the -X direction side of the ridge line of the wrinkle WR by being irradiated with the first irradiation light L1.

As illustrated in FIG. 4, the first light source 21 is disposed outside the -X direction end portion of the surface region SA of the medium M and at the +Z direction side of the medium M. The visible light L with which the first light source 21 irradiates the wrinkle WR is emitted obliquely downward from the upper left toward the lower right in the view of FIG. 4. As a result, the shadow LS and the bright portion LL are formed in the wrinkle WR generated in the surface region SA of the medium M. As illustrated in FIG. 3, since a difference in brightness between the shadow LS and the bright portion LL formed in the wrinkle WR is large, the presence or absence of the wrinkle WR generated in the surface region SA of the medium M can be easily confirmed.

Note that the incident angle of the first irradiation light L1 incident on the medium M from the first light source 21 with respect to a normal line of the surface region SA of the medium M is an angle exceeding 0°. When this angle is 0°, the shadow LS cannot be formed in the plurality of wrinkles WR. Further, the incident angle of the first irradiation light L1 incident on the medium M from the first light source 21 with respect to a normal line of the surface region SA of the medium M is an angle smaller than 90°. When this angle is 90°, the shadow LS formed in the tall wrinkle WR covers the short wrinkle WR located at the +X direction side with respect to the tall wrinkle WR, and thus, the bright portion LL cannot be formed in the short wrinkle WR.

Note that by changing the type of fabric, the height of the wrinkle WR generated in the surface region SA of the medium M, the length of the wrinkle WR extending in the conveyance direction F, and so on change. Even when the type of fabric is changed, in order to confirm the presence or absence of the wrinkle WR generated in the surface region SA of the medium M, the incident angle of the first irradiation light L1 incident on the medium M from the first light source 21 with respect to the normal line of the surface region SA of the medium M is preferably an angle within a range of 20° to 70°.

As described hereinabove, according to the recording apparatus 1 of the first embodiment, the following advantages can be obtained.

The recording apparatus 1 of the present embodiment includes the conveyance roller pair 10 including the main roller 14 that conveys the medium M in the conveyance direction F and the plurality of sub-rollers 16 that is disposed at intervals along the width direction H crossing the conveyance direction F and pinches the medium M with the main roller 14. Further, the recording apparatus 1 includes the recording head 5A that performs recording on the medium M, and the guide roller 11 that is disposed downstream in the conveyance direction F of the conveyance roller pair 10 and applies tension to the medium M. Further, the recording apparatus 1 includes the light source unit 20 capable of irradiating the surface region SA of the medium M conveyed in the air between the conveyance roller pair 10 and the guide roller 11 with the visible light L. Further, the luminous intensity in the width direction H of the visible light L with which the light source unit 20 irradiates the surface region SA is higher than the luminous intensity thereof in the conveyance direction F.

According to the present embodiment, since the luminous intensity in the width direction H of the visible light L with which the light source unit 20 irradiates the surface region SA is higher than the luminous intensity thereof in the conveyance direction F, when there is the wrinkle WR extending in the conveyance direction F in the surface region SA of the medium M, the shadow LS of the wrinkle WR can be formed in the surface region SA of the medium M. Accordingly, since it is possible to confirm the presence or absence of the wrinkle WR generated in the surface region SA of the medium M, it is possible to suppress the recording action from being performed without being aware of the wrinkle WR generated in the medium M. As a result, it is possible to suppress the possibility that deterioration in the image quality of the image recorded on the medium M or failure of the recording head 5A occurs.

Further, according to the present embodiment, since the light source unit 20 is disposed outside the surface region SA in the width direction H, the visible light L emitted from the light source unit 20 can form the shadow LS with respect to the wrinkle WR formed in the surface region SA of the medium M.

In addition, according to the present embodiment, since the light source unit 20 is capable of irradiating the region downstream in the conveyance direction F of the sub-roller 16 in the surface region SA with the visible light L, it is possible to form the shadow LS with respect to the wrinkle WR extending toward downstream in the conveyance direction F of the sub-roller 16.

Further, according to the present embodiment, the light source unit 20 can emit the visible light L toward the sub-roller 16. Each of the regions between the plurality of sub-rollers 16 arranged at intervals may become a starting point of occurrence of the wrinkle WR in some cases. In the present embodiment, since the shadow LS can be formed with respect to the starting point where the wrinkle WR occurs, the wrinkle WR can be quickly confirmed.

Further, according to the present embodiment, the recording apparatus 1 includes the housing 100 that houses the conveyance roller pair 10, the guide roller 11, and the light source unit 20, and the housing 100 is provided with the window portions 101, 102 through which the surface region SA irradiated with the visible light L can be visually recognized. Accordingly, the user can visually recognize, with ease, the presence or absence of the wrinkle WR generated in the surface region SA of the medium M from the window portions 101, 102.

Further, according to the present embodiment, since the window portions 101, 102 are formed of members that attenuate the transmitted light, the shadow LS formed by the light source unit 20 is less likely to be affected by the transmitted light incident from the outside of the housing 100. Accordingly, the user can visually recognize, with more ease, the presence or absence of the wrinkle WR generated in the surface region SA of the medium M from the window portions 101, 102.

### 2. Second Embodiment

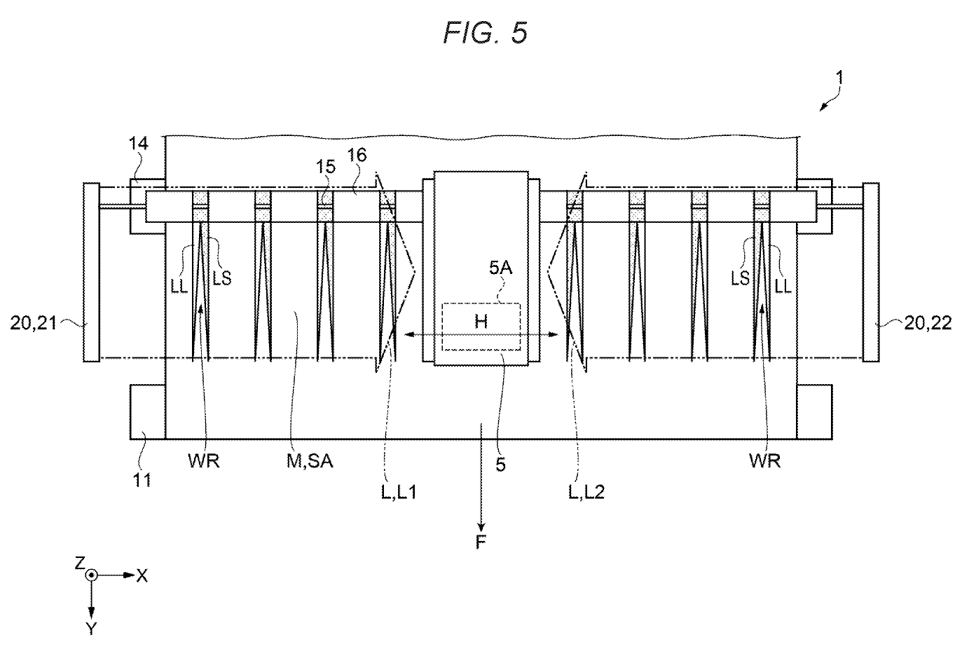

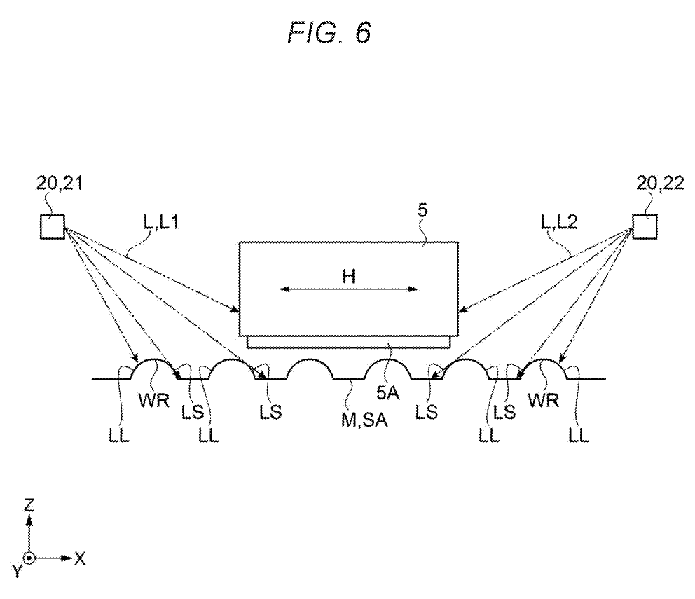

Hereinafter, a configuration for allowing the visual recognition of the wrinkle WR generated in the surface region SA of the medium M in a second embodiment will be described with reference to FIGS. 5 and 6. In FIGS. 5 and 6, the same components as those in the drawings having already been described are denoted by the same reference numerals to omit the detailed description thereof.

As shown in FIG. 5, the light source unit 20 further includes, in addition to the first light source 21 disposed outside one side in the width direction H of the surface region SA, a second light source 22 disposed outside the other side in the width direction H of the surface region SA. Note that FIG. 5 illustrates a state in which the moving unit 5 and the recording head 5A move from the home position located at the +X direction side of the recording apparatus 1 to a position facing the surface region SA of the medium M to be located at the +Z direction side of the surface region SA. That is, when the moving unit 5 moves to a position facing the surface region SA, the first light source 21 and the second light source 22 are disposed across the moving unit 5 in a plan view viewed from the +Z direction.

Similarly to the first embodiment, the recording apparatus 1 includes the first light source 21 outside the -X direction end portion of the medium M. In addition, the recording apparatus 1 includes the second light source 22 outside the +X direction end portion of the medium M. In the second embodiment, as the second light source 22, a light source formed of at least one white LED having a predetermined directional characteristic is exemplified. The second light source 22 is disposed outside the surface region SA of the medium M in the width direction H.

The second light source 22 can emit the visible light L toward the sub-rollers 16 and regions located downstream in the conveyance direction F of the sub-rollers 16 out of the surface region SA of the medium M.

Note that the visible light L emitted from the second light source 22 includes large amount of light emitted in a direction along an optical axis and also includes light diffused in other directions. In the present embodiment, the optical axis of the second light source 22 is directed to the surface region SA of the medium M located at the -X direction side of the second light source 22 out of the width direction H. That is, it is configured that the luminous intensity in the width direction H of the visible light L emitted from the second light source 22 to the surface region SA is higher than the luminous intensity thereof in the conveyance direction F. Out of the visible light L emitted from the second light source 22, light emitted in a direction along the optical axis is hereinafter referred to as second irradiation light L2. The second irradiation light L2 is emitted toward the surface region SA of the medium M located at the -X direction side of the second light source 22 out of the width direction H.

Accordingly, when the wrinkle WR extending in the conveyance direction F is present in the surface region SA of the medium M, the shadows LS of the wrinkles WR are formed in the surface region SA of the medium M by the second irradiation light L2 emitted from the second light source 22. In FIG. 5, the shadows LS are hatched.

The shadow LS is a dark portion darker than the surroundings other than the shadow LS. In the second embodiment, the shadow LS formed by the irradiation with the second irradiation light L2 is formed at the -X direction side of the ridge line of the wrinkle WR. In addition, at the +X direction side of the ridge line of the wrinkle WR, the bright portion LL brighter than the surroundings is formed by the irradiation with the second irradiation light L2.

As illustrated in FIG. 6, the first light source 21 and the second light source 22 are disposed at the +Z direction side with respect to the moving unit 5. Accordingly, for example, even when the moving unit 5 moves in the width direction H beyond the first light source 21 or the second light source 22, the first light source 21 and the second light source 22 do not interfere with the moving unit 5.

The second irradiation light L2 with which the second light source 22 irradiates the wrinkle WR is emitted obliquely downward from the upper right toward the lower left in the view of FIG. 6. As a result, the shadow LS and the bright portion LL are formed in the wrinkle WR generated in the surface region SA of the medium M.

In addition, since the moving unit 5 is interposed between the first light source 21 and the second light source 22 in a plan view viewed from the +Z direction as illustrated in FIG. 5, a part of the visible light L emitted from the first light source 21 toward the surface region SA of the medium M located at the +X direction side is blocked by the moving unit 5 as illustrated in FIG. 6. In addition, a part of the visible light L emitted from the second light source 22 toward the surface region SA of the medium M located at the -X direction side is blocked by the moving unit 5. That is, the first light source 21, the second light source 22, and the moving unit 5 are arranged so as to have a relationship in which a part of the visible light L emitted from the first light source 21 and a part of the visible light L emitted from the second light source 22 are each blocked by the moving unit 5. Further, the first light source 21, the second light source 22, and the moving unit 5 are arranged so as to have a relationship in which the first irradiation light L1 emitted from the first light source 21 and the second irradiation light L2 emitted from the second light source 22 do not overlap each other in the surface region SA of the medium M.

Note that since the first irradiation light L1 emitted from the first light source 21 and the second irradiation light L2 emitted from the second light source 22 are blocked by the moving unit 5, the shadow LS fails to be formed in the wrinkle WR generated in the surface region SA of the medium M facing the moving unit 5 in some cases. Alternatively, when the surface region SA of the medium M is visually recognized from the window portions 101, 102 of the housing 100, the surface region SA of the medium M is shielded by the moving unit 5, and thus the wrinkle WR generated in the surface region SA of the medium M cannot be visually recognized in some cases. However, since the moving unit 5 moves in the width direction H, the user can visually recognize the wrinkles WR with ease even when the visual recognition of the wrinkles WR is temporarily hindered by the moving unit 5.

In the second embodiment, the range of the incident angle of the second irradiation light L2 incident on the medium M from the second light source 22 with respect to the normal line of the surface region SA of the medium M is substantially the same as the range of the incident angle of the first irradiation light L1 incident on the medium M from the first light source 21 with respect to the normal line of the surface region SA of the medium M.

As described above, according to the recording apparatus 1 of the second embodiment, it is possible to further obtain the following advantages in addition to substantially the same advantages as those of the first embodiment.

According to the present embodiment, the recording apparatus 1 includes the moving unit 5 movable in the width direction H, and the light source unit 20 includes the first light source 21 disposed outside one side of the surface region SA in the width direction H and the second light source 22 disposed outside the other side of the surface region SA in the width direction H located across the moving unit 5 in plan view. As a result, since the first irradiation light L1 emitted from the first light source 21 and the second irradiation light L2 emitted from the second light source 22 are each blocked by the moving unit 5, the first light source 21 and the second light source 22 do not cancel out the shadows LS formed by each other.

### 3. Third Embodiment

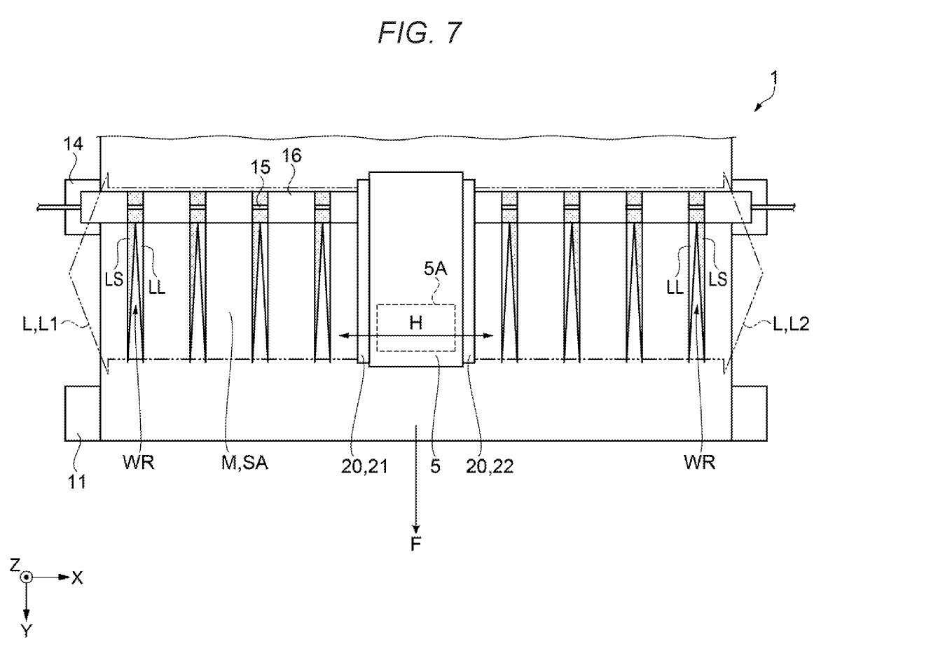

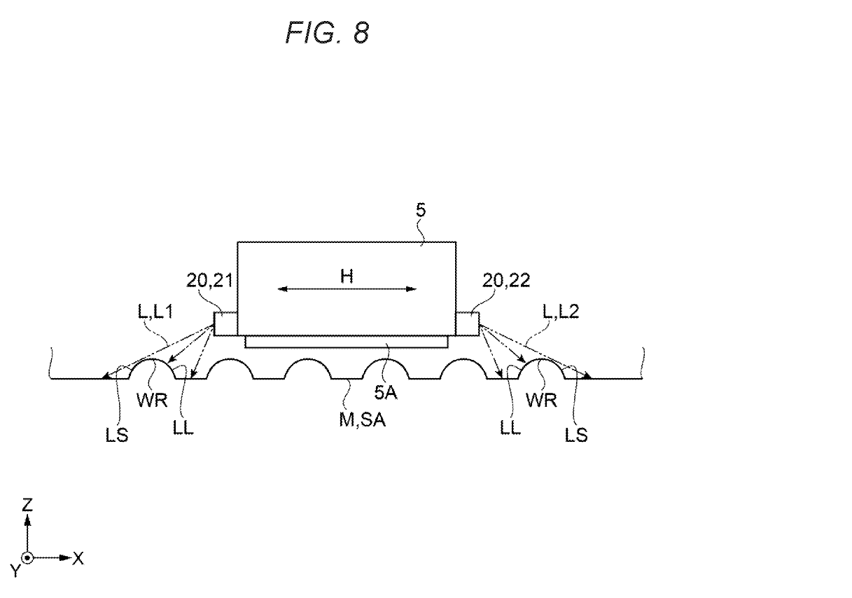

Hereinafter, a configuration for allowing the visual recognition of the wrinkle WR generated in the surface region SA of the medium M in a third embodiment will be described with reference to FIGS. 7 and 8. In the third embodiment, unlike the embodiments described above, the light source unit 20 is provided to the moving unit 5. In FIGS. 7 and 8, the same components as those in the drawings having already been described are denoted by the same reference numerals to omit the detailed description thereof. Note that FIG. 7 illustrates a state in which the moving unit 5 and the recording head 5A move from the home position located at the +X direction side of the recording apparatus 1 to a position facing the surface region SA of the medium M to be located at the +Z direction side of the surface region SA.

As illustrated in FIG. 7, the light source unit 20 includes the first light source 21 that irradiates the surface region SA at one side in the width direction H with respect to the moving unit 5, and the second light source 22 that irradiates the surface region SA at the other side in the width direction H with respect to the moving unit 5.

The first light source 21 is disposed at the -X direction side of the moving unit 5. The second light source 22 is disposed at the +X direction side of the moving unit 5. The light source unit 20 including the first light source 21 and the second light source 22 can move together with the moving unit 5 as the moving unit 5 moves. The first light source 21 can emit the visible light L toward the sub-rollers 16 and regions located downstream in the conveyance direction F of the sub-rollers 16 out of the surface region SA of the medium M. The second light source 22 can emit the visible light L toward the sub-rollers 16 and regions located downstream in the conveyance direction F of the sub-rollers 16 out of the surface region SA of the medium M.

Note that the visible light L emitted from the first light source 21 and the second light source 22 includes large amount of light emitted in a direction along an optical axis and also includes light diffused in other directions. In the present embodiment, the optical axis of the first light source 21 is directed to the surface region SA of the medium M located at the -X direction side of the first light source 21 out of the width direction H. Further, the optical axis of the second light source 22 is directed to the surface region SA of the medium M located at the +X direction side of the second light source 22 out of the width direction H. That is, it is configured that the luminous intensity in the width direction H of the visible light L emitted from the first light source 21 and the second light source 22 to the surface region SA is higher than the luminous intensity thereof in the conveyance direction F.

In the third embodiment, the first irradiation light L1 is the visible light L emitted toward the surface region SA of the medium M located at the -X direction side of the first light source 21 out of the width direction H. The second irradiation light L2 is the visible light L emitted toward the surface region SA of the medium M located at the +X direction side of the second light source 22 out of the width direction H. That is, the first irradiation light L1 and the second irradiation light L2 are the visible light L emitted toward respective directions opposite to each other without facing each other.

Accordingly, when the wrinkle WR extending in the conveyance direction F is present in the surface region SA of the medium M, the shadows LS of the wrinkles WR are formed in the surface region SA of the medium M by the visible light L emitted from the first light source 21 and the second light source 22. In FIG. 7, the shadows LS are hatched. The shadow LS is a dark portion darker than the surroundings other than the shadow LS.

In the third embodiment, the shadow LS formed by the irradiation with the first irradiation light L1 is formed at the -X direction side of the ridge line of the wrinkle WR. In addition, at the +X direction side of the ridge line of the wrinkle WR, the bright portion LL brighter than the surroundings is formed by the irradiation with the first irradiation light L1. Further, the shadow LS formed by the irradiation with the second irradiation light L2 is formed at the +X direction side of the ridge line of the wrinkle WR. In addition, at the -X direction side of the ridge line of the wrinkle WR, the bright portion LL brighter than the surroundings is formed by the irradiation with the second irradiation light L2.

The first light source 21 and the second light source 22 are disposed at both ends in the width direction H of the moving unit 5 and at the -Z direction end side of the moving unit 5 as illustrated in FIG. 8, but this is not a limitation. For example, the first light source 21 and the second light source 22 may be disposed at both ends in the direction along the Y axis of the moving unit 5, or may be disposed at the +Z direction side of the -Z direction end side of the moving unit 5. In the third embodiment, the first light source 21 and the second light source 22 move together with the moving unit 5. Since the first light source 21 and the second light source 22 do not interfere with the moving unit 5, the arrangement of the first light source 21 and the second light source 22 can be made closer to the surface region SA of the medium M than in the case of the second embodiment.

Accordingly, since the incident angles of the first irradiation light L1 and the second irradiation light L2 emitted from the light source unit 20 toward the surface region SA of the medium M can be made larger, the shadows LS longer in length are formed in the wrinkles WR generated in the surface region SA of the medium M. In addition, since the visible light L little in attenuation of illuminance can be emitted toward the surface region SA of the medium M, the shadow LS and the bright portion LL high in contrast are formed in each of the wrinkles WR generated in the surface region SA of the medium M.

The first irradiation light L1 with which the first light source 21 irradiates the wrinkle WR is emitted obliquely downward from the upper right toward the lower left in the view of FIG. 8. As a result, the shadow LS and the bright portion LL are formed in the wrinkle WR generated in the surface region SA of the medium M. Further, the second irradiation light L2 with which the second light source 22 irradiates the wrinkle WR is emitted obliquely downward from the upper left toward the lower right in the view of FIG. 8. As a result, the shadow LS and the bright portion LL are formed in the wrinkle WR generated in the surface region SA of the medium M.

In the third embodiment, the angle range of the incident angle of the first irradiation light L1 incident on the medium M from the first light source 21 with respect to the normal line of the surface region SA of the medium M is substantially the same as the angle range of the incident angle in the second embodiment. Further, the angle range of the incident angle of the second irradiation light L2 incident on the medium M from the second light source 22 with respect to the normal line of the surface region SA of the medium M is substantially the same as the angle range of the incident angle in the second embodiment.

As described above, according to the recording apparatus 1 of the third embodiment, it is possible to further obtain the following advantages in addition to substantially the same advantages as those of the first embodiment.

According to the present embodiment, since the recording apparatus 1 includes the moving unit 5 that is movable in the width direction H, and the light source unit 20 moves together with the moving unit 5, it is possible to irradiate the surface of the medium M with the visible light L at predetermined illuminance due to the movement of the moving unit 5 regardless of the location on the surface of the medium M. As a result, regardless of the location on the surface of the medium M, the shadow LS high in contrast can be formed in the wrinkle WR generated in the medium M, and thus the wrinkle WR generated in the surface region SA of the medium M can easily be confirmed.

In addition, according to the present embodiment, since the light source unit 20 is capable of irradiating the region downstream in the conveyance direction F of the sub-roller 16 in the surface region SA with the visible light L, it is possible to form the shadow LS with respect to the wrinkle WR extending toward downstream in the conveyance direction F of the sub-roller 16.

Further, according to the present embodiment, the light source unit 20 can emit the visible light L toward the sub-roller 16. Each of the regions between the plurality of sub-rollers 16 arranged at intervals may become a starting point of occurrence of the wrinkle WR in some cases. In the present embodiment, since the shadow LS can be formed with respect to the starting point where the wrinkle WR occurs, the wrinkle WR can be quickly confirmed.

Further, according to the present embodiment, the light source unit 20 includes the first light source 21 that irradiates the surface region SA at one side in the width direction H with respect to the moving unit 5, and the second light source 22 that irradiates the surface region SA at the other side in the width direction H with respect to the moving unit 5. As a result, it becomes possible for the first light source 21 and the second light source 22 to emit the visible light L toward the respective sides opposite to each other, and thus the first light source 21 and the second light source 22 do not cancel out the shadows LS formed by each other. Further, it is possible to change the shape of the shadow LS and reverse the direction of the shadow LS due to the movement of the moving unit 5. Accordingly, it is possible to easily confirm the wrinkle WR generated in the surface region SA of the medium M.

Although the embodiments are hereinabove described in detail with reference to the drawings, the specific configuration is not limited to the embodiments and may be modified, replaced, deleted, or the like without departing from the gist of the present disclosure. Further, other embodiments described below may be adopted. Substantially the same advantages as those of the embodiments can also be obtained by the other embodiments.

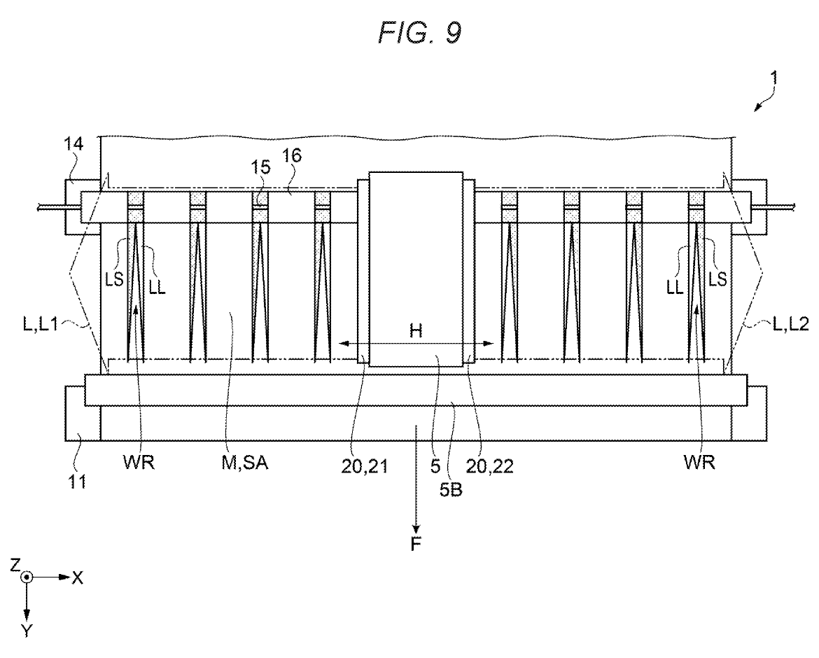

The recording apparatus 1 including the serial head type recording head 5A mounted on the moving unit 5 is exemplified in each of the embodiments described above, but this is not a limitation, and a line head type may be adopted. For example, as illustrated in FIG. 9, the recording apparatus 1 may include the moving unit 5 and a line head 5B. Similarly to the third embodiment, the moving unit 5 is equipped with the light source unit 20, but is not equipped with the recording head 5A. The moving unit 5 is movable in the width direction H independently of the printing operation. The line head 5B is disposed downstream in the conveyance direction F of the moving unit 5 in FIG. 9, but the line head 5B may be disposed upstream in the conveyance direction F of the moving unit 5. The line head 5B covers the surface region SA of the medium M in the width direction H and is disposed facing the surface region SA of the medium M. The line head 5B records an image on the surface region SA of the medium M by ejecting the liquid onto the medium M. Note that other components than the moving unit 5 and the line head 5B are substantially the same as those in the third embodiment.

In the embodiments described above, it is assumed that the first irradiation light L1 and the second irradiation light L2 emitted from the light source unit 20 are emitted toward the directions along the X axis, but this is not a limitation. For example, the first irradiation light L1 and the second irradiation light L2 emitted from the light source unit 20 may be emitted in other directions than the directions along the X axis. By, for example, providing a reflector to the recording apparatus 1, the first irradiation light L1 and the second irradiation light L2 emitted toward other directions than the directions along the X axis may be changed in irradiation angle by the reflector, and then emitted toward the directions along the X axis.

In the embodiments described above, the visible light L emitted from the light source unit 20 may include larger amount of light directed in the conveyance direction F than light directed in the width direction H in some cases. For example, the light directed in the conveyance direction F may be emitted in the direction along the X axis after being changed in irradiation angle by the reflector, or the surface region SA of the medium M may be prevented from being irradiated with the light directed in the conveyance direction F by a cover or the like that shields the light directed in the conveyance direction F.

In the embodiments described above, the shadow LS and the bright portion LL are formed by irradiating the wrinkle WR having a convex shape generated in the surface region SA of the medium M with the visible light L from the light source unit 20, but even when a concave wrinkle is generated in the surface region SA of the medium M, the shadow LS and the bright portion LL are formed in substantially the same manner.

In the embodiments described above, the timing at which the visible light L is emitted from the light source unit 20 may be when the medium M is set in the conveyance unit 3, before an image is recorded on the medium M, or during recording of an image on the medium M.

The wrinkle WR generated in the medium M in each of the embodiments described above may be removed by rewinding the medium M to the roll body R1 and then setting the medium M in the conveyance unit 3 so that the wrinkle WR is not generated. Alternatively, for example, the recording apparatus 1 may include, in the conveyance roller pair 10, a release unit that releases pinching of the medium M, and the wrinkle WR generated in the medium M may be removed after the pinching of the medium M is released by the release unit. By providing the release unit, it is not necessary to rewind the medium M to the roll body R1 in order to remove the wrinkle WR generated in the medium M.

In the second embodiment described above, there is adopted that configuration in which the first irradiation light L1 emitted from the first light source 21 and the second irradiation light L2 emitted from the second light source 22 are shielded by the moving unit 5, but this is not a limitation. For example, one of the first light source 21 and the second light source 22 may selectively emit the visible light L.

In the third embodiment and the other embodiment illustrated in FIG. 9, the first light source 21 and the second light source 22 are disposed at both sides in the width direction H of the moving unit 5, but this is not a limitation. For example, any one of the first light source 21 and the second light source 22 may be disposed in the moving unit 5. Alternatively, when the first light source 21 and the second light source 22 are disposed at both sides in the width direction H, any one of the first light source 21 and the second light source 22 may selectively emit the visible light L.

What is claimed is:

1. A recording apparatus comprising:
a conveyance roller pair including a main roller configured to convey a medium in a conveyance direction, and a plurality of sub-rollers disposed at intervals along a width direction crossing the conveyance direction and configured to pinch the medium with the main roller;
a recording head configured to perform recording on the medium;
a guide roller disposed downstream in the conveyance direction of the conveyance roller pair and configured to apply tension to the medium; and
a light source unit configured to irradiate, with visible light, a surface region of the medium conveyed in air between the conveyance roller pair and the guide roller,
wherein
luminous intensity in the width direction of the visible light with which the light source unit irradiates the surface region is higher than luminous intensity thereof in the conveyance direction.

2. The recording apparatus according to claim 1, wherein
the light source unit is disposed outside the surface region in the width direction.

3. The recording apparatus according to claim 2, wherein
the light source unit is configured to irradiate, with the visible light, a region downstream in the conveyance direction of the sub-rollers out of the surface region.

4. The recording apparatus according to claim 2, wherein
the light source unit is configured to emit the visible light toward the sub-rollers.

5. The recording apparatus according to claim 2, further comprising
a moving unit configured to move in the width direction, wherein
the light source unit includes a first light source disposed outside one side in the width direction of the surface region and a second light source disposed outside another side in the width direction of the surface region across the moving unit in plan view.

6. The recording apparatus according to claim 1, further comprising
a moving unit configured to move in the width direction, wherein
the light source unit moves together with the moving unit.

7. The recording apparatus according to claim 6, wherein
the light source unit is configured to irradiate, with the visible light, a region downstream in the conveyance direction of the sub-rollers out of the surface region.

8. The recording apparatus according to claim 6, wherein
the light source unit is configured to emit the visible light toward the sub-rollers.

9. The recording apparatus according to claim 6, wherein
the light source unit includes a first light source configured to irradiate the surface region at one side in the width direction with respect to the moving unit, and a second light source configured to irradiate the surface region at another side in the width direction with respect to the moving unit.

10. The recording apparatus according to claim 1, further comprising
a housing configured to house the conveyance roller pair, the guide roller, and the light source unit, wherein
the housing is provided with a window portion through which the surface region irradiated with the visible light is visually recognized.

11. The recording apparatus according to claim 10, wherein
the window portion is formed of a member configured to attenuate transmitted light.
